(19) United States
(12) Patent Application Publication
(10) Pub. No.: US 2007/0098151 A1
(43) Pub. Date: May 3, 2007

(54) Cryptographic protocol security verification apparatus, cryptographic protocol design apparatus, cryptographic protocol security verification method, cryptographic protocol design method and computer program product

(75) Inventor: Hirofumi Muratani, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/488,942

(22) Filed: Jul. 18, 2006

(30) Foreign Application Priority Data
Jul. 20, 2005 (JP) 2005-210533

(51) Int. Cl. H04L 9/28; H04L 9/00; H04K 1/00

(52) U.S. Cl. 380/28

(57) ABSTRACT

A cryptographic protocol security verification apparatus includes a formal verification unit verifying a presence or absence of a defect of a process for a party and a first virtual entity based on a description of a verifiable cryptographic protocol specification data, wherein the verifiable cryptographic protocol specification data includes a first description section containing a description of a process for the party actually involved in the execution of a cryptographic protocol, and a second description section, where the second description section corresponds to an ideal protocol defined by an universal composability and containing the description of the process for the party actually involved in the execution of the cryptographic protocol and a first virtual entity not actually involved in the execution of the cryptographic protocol, and does not contain a description for a second virtual entity not actually involved in the execution of the cryptographic protocol, and wherein the first virtual entity corresponds to an ideal functionality of the ideal protocol, and the second virtual entity corresponds to a simulator of the ideal protocol.

### CROSS-REFERENCE TO RELATED APPLICATIONS

This application is based upon and claims the benefit of priority from the prior Japanese Patent Application No. 2005-210533, filed on Jul. 20, 2005; the entire contents of which are incorporated herein by reference.

### BACKGROUND OF THE INVENTION

1. Field of the Invention

The present invention relates to a cryptographic protocol security verification apparatus for verifying the security as to whether a cryptographic protocol has a defect or not, a cryptographic protocol security verification method, a cryptographic protocol security verification program, a cryptographic protocol design apparatus for designing a cryptographic protocol by verifying the security thereof and a computer program product.

2. Description of the Related Art

Techniques for verifying the security of a cryptographic protocol utilizing a cryptographic method are known to include a FV (Formal Verification) and a Complexity-Theoretic Proof.

The formal verification, as disclosed in Abadi, M. Rogaway, P.: Reconciling Two Views of Cryptography, In: IFIP International Conference on Theoretical Computer Science (2000), is a method for formally verifying the legitimacy of a protocol from the description of the cryptographic protocol specification. The complexity-theoretic proof, on the other hand, is a method of attributing the failure of the protocol security to the difficulty of a mathematic problem.

As a complexity-theoretic proof, a verification method called the modular approach has been suggested. In this modular approach, the security of a protocol is proven under a given assumption, and then the assumed portion is converted to a safe protocol also in the realistic situation. As a method of verifying the security of a cryptographic protocol based on this modular approach, the proof based on the Universal Composability (UC) has recently been proposed.

The proof according to this UC is formulated based on a simulation paradigm, and the secure realization of an ideal functionality F by a given protocol π is defined as the fact that two systems including a real model and an ideal process cannot be distinguished by the stochastic polynomial time Turing machine E (hereinafter referred to the environment E), or strictly, the fact that a simulator S of an ideal process exists for an arbitrary adversary A of the real model and the two systems cannot be distinguished by any environment E. As disclosed in Canetti, R: Universally Composable Security; A new Paradigm for Cryptographic Protocols. In: FOCS' 01, IEEE (2001) 136-145, according to UC, as long as a given protocol π is proven to realize the ideal functionality F securely, it is proven that the protocol π is secure by the universal composability theorem even when a protocol ρ for accessing the particular protocol π as a subroutine is executed and regardless of how many times the protocol π is accessed in the protocol ρ.

However, this conventional method of verifying the security of the cryptographic protocol poses the problem described below. Specifically, the formal verification cannot easily verify a complicated cryptographic protocol due to a great amount of calculations thereof and requires the assumption of security of the primitives.

In the complexity-theoretic proof, on the other hand, the cryptographic protocols having the security proof are limited, and once a cryptographic protocol is corrected, even if slightly, a renewed security proof is required. Thus, a great amount of labor is required for security verification of the cryptographic protocol.

In the modular approach such as UC, the labor of proving the security of a cryptographic protocol is saved by a structural proving method in which the security of a protocol is proven under a given assumption and then the particular assumed portion is converted into a safe protocol in realistic situations. For a complicated cryptographic protocol, however; the labor of proving the protocol security cannot be exhibited efficiently.

### SUMMARY OF THE INVENTION

According to one aspect of the present invention, a cryptographic protocol security verification apparatus includes a formal verification unit verifying a presence or absence of a defect of a process for a party and a first virtual entity based on a description of a verifiable cryptographic protocol specification data, wherein the verifiable cryptographic protocol specification data includes a first description section containing a description of a process for the party actually involved in the execution of a cryptographic protocol, and a second description section, where the second description section corresponds to an ideal protocol defined by an universal composability, contains a description of the process for the party actually involved in the execution of the cryptographic protocol and a first virtual entity not actually involved in the execution of the cryptographic protocol, and does not contain a description for a second virtual entity not actually involved in the execution of the cryptographic protocol, and wherein the first virtual entity corresponds to an ideal functionality of the ideal protocol, and the second virtual entity corresponds to a simulator of the ideal protocol.

According to another aspect of the present invention, a cryptographic protocol design apparatus includes a cryptographic protocol part storage unit storing a first description part and a second description part, wherein the first description part constituting a first description section providing a description of processes for a party actually involved in a execution of a cryptographic protocol and the second description part constituting a second description section providing a description of processes for the party actually involved in the execution of the cryptographic protocol and for a first virtual entity and a second virtual entity not actually involved in the execution of the cryptographic protocol, these processes being proven to be realized securely by the first description section, a cryptographic protocol specification design unit generating a cryptographic protocol specification data containing the second description part stored in the cryptographic protocol part storage unit and the first description section newly added, a verifiable cryptographic protocol generating unit generating a verifiable cryptographic protocol specification data by deleting the description on the second virtual entity from the second description section in the cryptographic protocol specification data generated by the cryptographic protocol specification design unit, a formal verification unit verifying, based on the description of the verifiable cryptographic protocol specification data, a presence or absence of a defect of the process for both the party and the first virtual entity in the verifiable cryptographic protocol specification data generated by the verifiable cryptographic protocol specification generating unit, and a cryptographic protocol execution unit generating a realizable cryptographic protocol based on the verifiable cryptographic protocol specification data proven to have no defect by the formal verification unit.

According to still another aspect of the present invention, a method of verifying a cryptographic protocol security includes verifying a presence or absence of a defect of a process for a party and a first virtual entity based on a description of a verifiable cryptographic protocol specification data, wherein the verifiable cryptographic protocol specification data includes a first description section containing a description of a process for the party actually involved in the execution of a cryptographic protocol, and a second description section, where the second description section corresponds to an ideal protocol defined by an universal composability, contains a description of the process for the party actually involved in the execution of the cryptographic protocol and a first virtual entity not actually involved in the execution of the cryptographic protocol, and does not contain a description for a second virtual entity not actually involved in the execution of the cryptographic protocol, and wherein the first virtual entity corresponds to an ideal functionality of the ideal protocol, and the second virtual entity corresponds to a simulator of the ideal protocol.

According to still another aspect of the present invention, a method of designing a cryptographic protocol includes generating a cryptographic protocol specification data including a second description part being stored in a cryptographic protocol part storage unit and a newly added first description section, wherein the cryptographic protocol part storage unit store a first description part constituting the first description section providing a description of a process for a party actually involved in an execution of a cryptographic protocol and the second description part constituting a second description section providing a description of processes for the party actually involved in the execution of the cryptographic protocol and for a first virtual entity and a second virtual entity not actually involved in the execution of the cryptographic protocol, these processes being proven to be realized securely by the first description section, generating a verifiable cryptographic protocol specification data by deleting the description on the second virtual entity from the second description section in the cryptographic protocol specification data generated, verifying, based on the description of the verifiable cryptographic protocol specification data, a presence or absence of a defect of the process for both the party and the first virtual entity in the verifiable cryptographic protocol specification data generated, and generating a realizable cryptographic protocol based on the verifiable cryptographic protocol specification data proven to have no defect.

A computer program product according to still another aspect of the present invention causes a computer to perform the above methods according to the present invention.

### BRIEF DESCRIPTION OF THE DRAWINGS

FIG. 1 is a block diagram showing a functional configuration of a cryptographic protocol security verification apparatus according to a first embodiment;

FIG. 2 is a schematic diagram for briefly explaining the UC;

FIG. 3 is a diagram for explaining an example of the signature ideal functionality FSIG constituting an ideal functionality of a signature;

FIG. 4 is a diagram for explaining an example of a protocol πₛ;

FIG. 5 is a schematic diagram showing a data structure of a verifiable cryptographic protocol specification data 500 input through a cryptographic protocol security verification apparatus according to a first embodiment;

FIG. 6 is a diagram for explaining an example of a first description section 501 of the verifiable cryptographic protocol specification data 500;

FIG. 7A is a diagram for explaining an example of the description using the ideal functionality in the cryptographic protocol specification;

FIG. 7B is diagram for explaining an example of a protocol execution definition part of a second description section 502 of the verifiable cryptographic protocol specification data 500;

FIG. 8 is a flowchart showing the procedures of the security verification process of a cryptographic protocol according to the first embodiment;

FIG. 9A is a flowchart showing the procedures of the inference execution process by an inference execution unit 122;

FIG. 9B is a flowchart (continued from FIG. 9A) showing the procedures of the inference execution process by the inference execution unit 122;

FIG. 10 is a block diagram showing a functional configuration of the cryptographic protocol security verification apparatus according to a second embodiment;

FIG. 11 is a flowchart showing the procedures of the process for generating the verifiable cryptographic protocol specification data 500 by a verifiable cryptographic protocol specification generating unit 1010;

FIG. 12 is a diagram for explaining an example of the authentication channel ideal functionality F_{AUTH} providing an ideal functionality of a channel having the authentication functionality;

FIG. 13 is a flowchart showing the procedures of the process for generating the verifiable cryptographic protocol specification data 500 by the verifiable cryptographic protocol specification generating unit 1010 according to a modification of the second embodiment;

FIG. 14 is a block diagram showing a functional configuration of a cryptographic protocol design apparatus according to a third embodiment; and

FIG. 15 is a flowchart showing the procedures of the process for designing a cryptographic protocol by the cryptographic protocol design apparatus 1200.

### DETAILED DESCRIPTION OF THE PREFERRED EMBODIMENTS

A cryptographic protocol security verification apparatus, a cryptographic protocol design apparatus, a cryptographic protocol security verification method, a cryptographic protocol design method, a cryptographic protocol security verification program, a cryptographic protocol design program and a computer program product according to preferred embodiments of the invention are described in detail below with reference to the accompanying drawings.

A first embodiment is described.

A cryptographic protocol security verification apparatus according to the first embodiment is supplied with a verifiable cryptographic protocol specification data configured of a first description section describing the process for a party actually involved in the execution of a cryptographic protocol and a second description section describing the process for a party including an entity for the ideal functionality defined by the universal composability without the description about a simulator as an attacker and describing the process for a party actually involved in the execution of the cryptographic protocol and the process for a first virtual entity not actually involved in the execution of the cryptographic protocol, thereby to verify the security of the cryptographic protocol specification data.

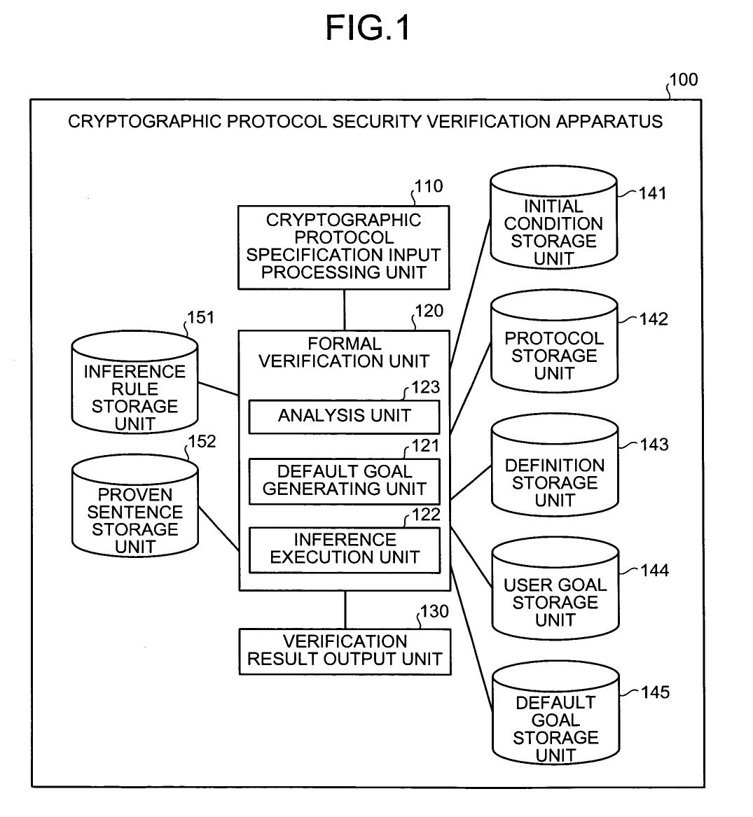

FIG. 1 is a block diagram showing a functional configuration of a cryptographic protocol security verification apparatus according to the first embodiment. The cryptographic protocol security verification apparatus 100 according to this embodiment, as shown in FIG. 1, is mainly configured with a cryptographic protocol specification input processing unit 110, a formal verification unit 120, a verification result output unit 130, an initial condition storage unit 141, a protocol storage unit 142, a definition storage unit 143, a user goal storage unit 144, a default goal storage unit 145, an inference rule storage unit 151 and a proven sentence storage unit 152.

The cryptographic protocol specification input processing unit 110 processes the input of a verifiable cryptographic protocol specification data. The verifiable cryptographic protocol specification data includes a first description section described according to the protocol specification for the formal verification (FV) and a second description section described based on the protocol specification for the UC (Universal Composability) of the complexity-theoretic proof. In the second description section, not only the cryptographic protocol is described by the protocol specification of UC, but the ideal functionality is added as a first virtual entity from the UC description and the description of the simulator constituting the attacker as a second virtual entity is not contained. That is, the specification in UC and the specification in the formal verification are matched in the description. Thus, a cryptographic protocol specification is provided in which while securing the primitive security by the cryptographic protocol, the mechanical security verification by the formal proof is possible at the same time. This cryptographic protocol specification data contains the description divided into the initial condition part, the definition part, the protocol execution definition part and the goal part.

The formal verification unit 120 is a processing unit for verifying the security, by the formal verification (FV), of the cryptographic protocol specification described in the verifiable cryptographic protocol specification data input, and verifies the presence or absence of a defect of the process for both the party actually involved in the execution of the cryptographic protocol in the first description section described later and the first virtual entity not actually involved in the execution of the cryptographic protocol in the first description section and the second description section. The formal verification unit 120, as shown in FIG. 1, includes a protocol analysis unit 123, a default goal generating unit 121 and an inference execution unit 122.

The analysis unit 123 analyzes the verifiable cryptographic protocol specification data, extracts the initial condition part, the definition part, the protocol execution definition part and the goal part, and stores the description of the initial condition part in the initial condition storage unit 141 and the description of the definition part in the definition storage unit 142. Also, the analysis unit 123 analyzes the verifiable cryptographic protocol specification data, and stores the description of the goal part in the user goal storage unit 144 with the sentence constituting the proof goal in the backward inference as a user goal.

The default goal generating unit 121 is a processing unit in which the default goal providing a goal sentence to be proven in the backward inference is set from the description of the process for both the party and the virtual party at each stage of the protocol execution definition part in the verifiable cryptographic protocol specification data and stored in the default goal storage unit 145. The default goal is a sentence for each stage concerning, for example, whether the sender could transmit a particular message, whether the receiver could decode the encrypted portion of the message, whether the receiver can determine a particular party who has transmitted the encrypted or hushed field of the message, or whether the receiver has the reason to believe the related sentence bound to the transmission of the particular message.

The inference execution unit 122 is a processing unit for determining whether the default goal sentence, the user goal sentence and the cryptographic protocol specification data verifiable by the backward inference from the inference rule stored in the initial condition storage unit 141 or the proven sentence storage unit 152 and the inference rule storage unit 151 have a defect or not, i.e. verifying the security of the cryptographic protocol. Specifically, the inference execution unit 122 retrieves, in the order of the stages of the protocol execution definition part, whether a sentence equivalent to the default goal sentence is existent in the initial condition storage unit 141 storing the sentence assumed to be correct in the initial verification stage or the proven sentence storage unit 152 storing the sentence verified to be correct in the process of verification of the stage before the current stage. Also, the inference execution unit 122 retrieves whether a sentence equivalent to the user goal sentence is existent or not in the initial condition storage unit 141 or the proven sentence storage unit 152. When the sentences equivalent to all the sentences in the default goal and in the user goal of all the stages are existent in the initial condition storage unit 141 or the proven sentence storage unit 152, the inference execution unit 122 proves the security of the cryptographic protocol as free of a defect.

The verification result output unit 130 is a processing unit for outputting the result (safe or not safe) as to the security of the cryptographic protocol verified by the inference execution unit 122 to the display unit such as a display and a printer.

The initial condition storage unit 141 is for holding the contents of the description of the initial condition part extracted from the cryptographic protocol specification data by the analysis unit 123, i.e. the sentence assumed to be correct in the initial stage of verification. The protocol storage unit 142 holds the contents of the description of the protocol execution definition part extracted from the cryptographic protocol specification data by the analysis unit 123. The definition storage unit 143 holds the contents of the description of the definition part extracted from the cryptographic protocol specification data by the analysis unit 123. The user goal storage unit 144 holds the contents of the description of the goal part extracted from the cryptographic protocol specification data by the analysis unit 123.

The default goal storage unit 145 holds the aforementioned default target generated by the default goal generating unit 121.

The inference rule storage unit 151 holds the existing inference rule having the conclusion part expressed in the premise part or the conjunctive form. According to this embodiment, the inference rule of BGNY2 providing a formulated rule of the proof inference derived from the GNY (Gong-Needham-Yahalom) logic is stored in the inference rule storage unit 151. Incidentally, according to this embodiment, the BGNY2 inference rule corresponding to the backward inference conducted by the inference execution unit 122 is stored in the inference rule storage unit 151. The present invention, however, is not limited to this configuration but an arbitrary inference rule can be stored in the inference rule storage unit 151 in accordance with the inference method executed.

The proven sentence storage unit 152 stores the sentence proven to have no defect (true) in the stages before the current stage in the verification process by the inference execution unit 122.

The initial condition storage unit 141, the protocol storage unit 142, the definition storage unit 143, the user goal storage unit 144, the default goal storage unit 145, the inference rule storage unit 151 and the proven sentence storage unit 152 are each formed of a storage medium such as a memory or a HDD (hard disk drive).

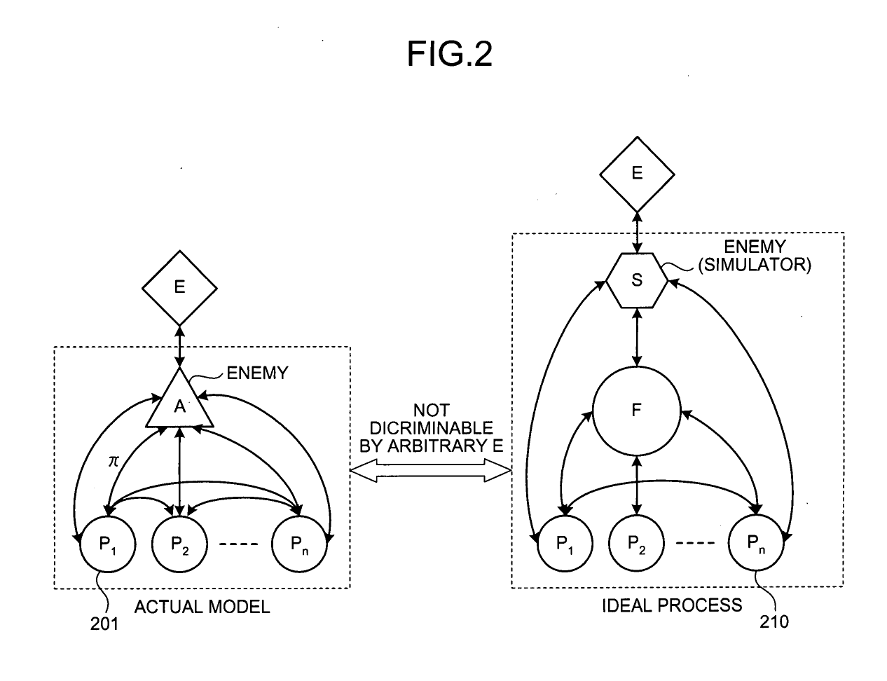

Next, the universal composability (hereinafter referred to as the “UC”) is briefly explained. FIG. 2 is a schematic diagram for explaining the outline of the UC. Two systems are shown in FIG. 2. One is a system of a real model in which the message is exchanged in accordance with the protocol π between the parties Pᵢ actually involved in the protocol execution or between the party Pᵢ and the adversary A constituting an attacker. The other is a system of an ideal process corresponding to the real model, in which the message exchange between the parties Pᵢ actually involved in the protocol execution or with the simulator S as an attacker is conducted utilizing the ideal functionality F providing a first virtual entity not actually involved in the protocol execution.

In the UC, the secure realization of the ideal functionality F by a given protocol π is defined as the inability of the stochastic polynomial time Turing machine (PPT) (hereinafter referred to as the environment E) to discriminate the two systems of the real model and the ideal process. That is, a given simulator S of the ideal process is existent against an arbitrary adversary A of the real model, and the two systems cannot be distinguished by any environment E. In the UC, assume that a given protocol π can be proved to securely realize the ideal functionality F. Even when a protocol ρ is executed for accessing the protocol π as a subroutine, it can be proven that the security of the protocol π can be maintained regardless of how many times the protocol π is accessed in the protocol ρ (universal composability theorem).

The UC includes several formulations. In one of them, the simulator S can read the address of a message exchanged between the ideal functionality F and each party Pᵢ, but cannot check the contents thereof. Further, the simulator S (adversary) immediately distributes the message to the party Pᵢ at the request of the ideal functionality F. Nevertheless, the message may not be distributed in spite of the request. Further, a message not requested may be distributed.

In another UC formulation, the message is exchanged directly between the ideal functionality F and the party Pᵢ without the intermediary of the simulator. In this case, the simulator S cannot recognize the message exchanged between the ideal functionality F and the party Pᵢ unless the particular party is corrupted. When the ideal functionality F permits the distribution of the message to the simulator S expressly in terms of the specification thereof, however, the simulator S can be informed of the contents of the message.

In the UC, the cryptographic protocol (or a part thereof) is equivalent to the ideal functionality F. This equivalence indicates that an arbitrary attack by the adversary A in the real model cannot be metrically distinguished from the attack by the simulator S in the ideal process. Therefore, assuming that the ideal functionality F has the specification to hide the detail of the calculation and the exchange of the message of the cryptographic protocol and keep the contents of the message confidential, no matter how the adversary A collects the detailed information in the real model, the adversary A cannot make the attack which is impossible for the simulator even by using the information invisible from the simulator S with regard to the portion of the cryptographic protocol at least described in the ideal functionality.

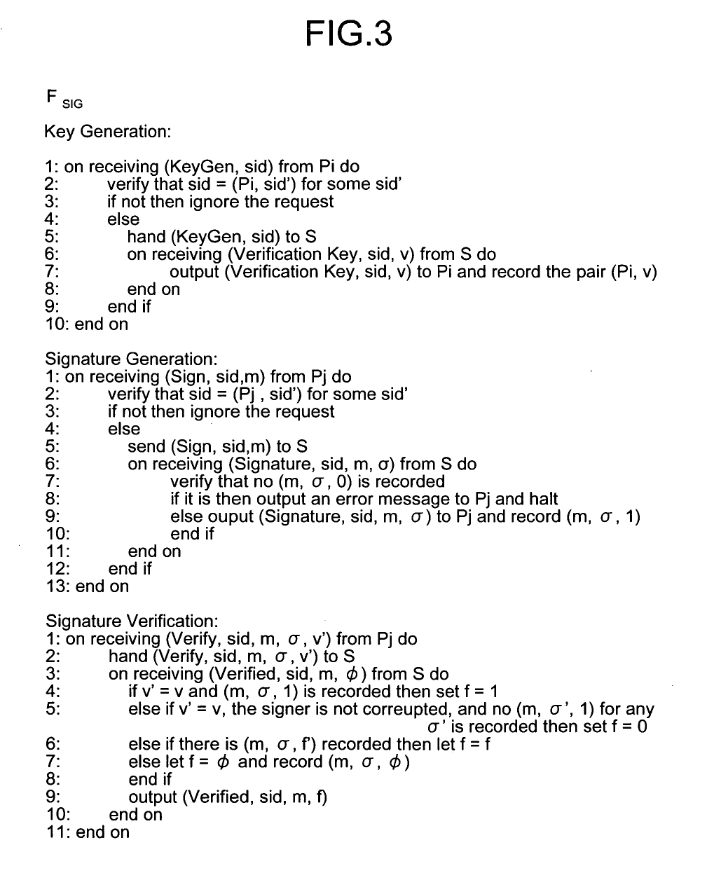

FIG. 3 is a diagram for explaining an example of the signature ideal functionality F_{SIG} constituting one of the ideal functionalities on the signature. The signature ideal functionality F_{SIG} has the feature that a verification key is assigned by the simulator S as an adversary. Pᵢ is a virtual party not actually involved in the execution of the protocol.

In the protocol for the formal verification (FV), on the other hand, the adversary S makes no express appearance in the description of the specification. When the description of the specification including the ideal functionality is input to the formal verification unit 120 for formal verification, therefore, the difference in verification method is required to be taken into consideration. According to this embodiment, the second description section using the ideal functionality F as a verifiable cryptographic protocol specification constitutes a protocol having the description in which the process for the simulator is deleted and the ideal functionality executes the process in place of the simulator.

Also, the adversary S plays the role of determining whether the signature verification is accepted or not. An internal process in the ideal functionality F_{SIG} cannot be known by the adversary S. The message exchanged by the ideal functionality F_{SIG} with other parties, however, is formulated to be known by the simulator S.

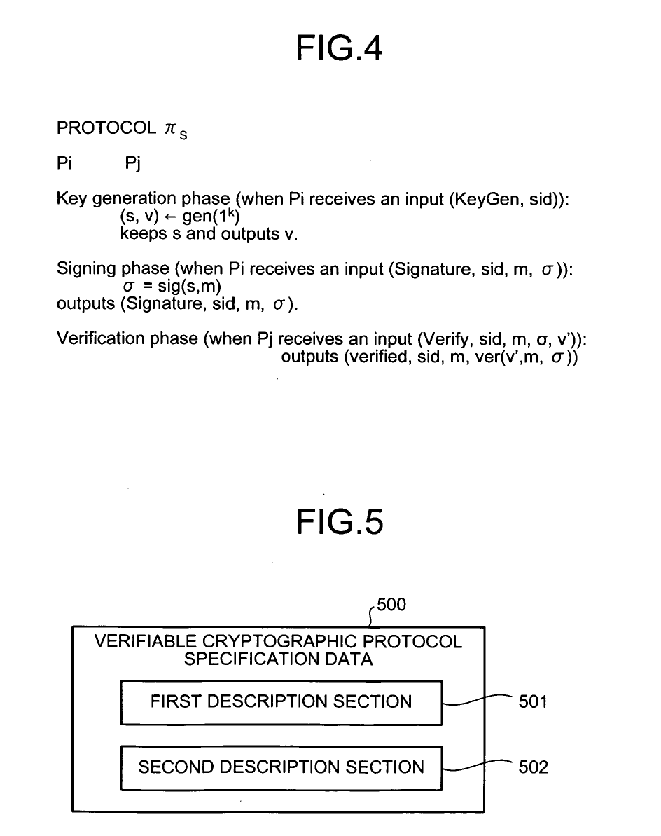

Also, with regard to the protocol signature scheme S=(gen, sig, ver) for realizing the ideal functionality F_{SIG}, the protocol πₛ is defined as shown in FIG. 4. In the process, the fact that the scheme S is an existentially unforgeable signature scheme against the adaptive chosen-message attack is known to be equivalent to the secure realization of the ideal functionality F_{SIG} by the protocol πₛ. Character Pᵢ designates a party actually involved in the execution of the protocol.

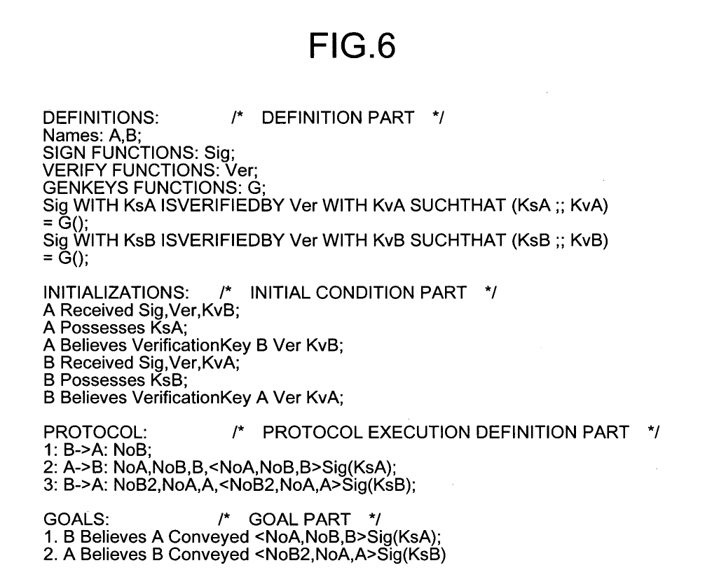

FIG. 5 is a schematic diagram showing the data structure of the verifiable cryptographic protocol specification data input by the cryptographic protocol security verification apparatus according to the first embodiment. As shown in FIG. 5, the verifiable cryptographic protocol specification data 500 is configured of the first description section 501 and the second description section 502. The first description section 501 has described therein the protocol of a real model in accordance with the protocol specification in the formal verification (FV). The second description section 502, on the other hand, has described therein a protocol providing the description of the process of the simulator S executed by the ideal functionality F in place of the simulator based on the description of the protocol specification utilizing the ideal functionality F corresponding to the protocol π of the real model of the first description section 501.

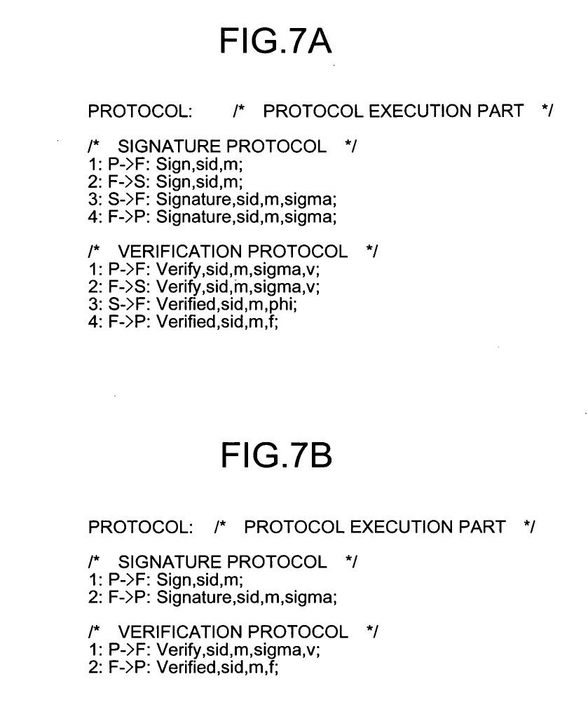

FIG. 6 is a diagram for explaining an example of the first description section 501 of the verifiable cryptographic protocol specification data 500. The example shown in FIG. 6 represents a case in which the specification of the initial version of the mutual authentication protocol ISO/IEC 9798-3 utilizing the electronic signature is described by a language extended from ISL2 (Interface Specification Language, Version 2). The cryptographic protocol specification data, as shown in FIG. 6, is configured of the definition part, the initial condition part, the protocol execution definition part and the goal part, and contains the description of the process for the party actually involved in the execution of the cryptographic protocol.

Originally, the description specification of the electronic signature in ISL2 is defined as [x] (f, h) (k), for example. This definition represents a message x with a signature, and indicates that the signature is obtained by encryption using the encryption function f after applying the hush function h to x. In the process, character k designates an encryption key. Many of the electronic signature systems of which security is proven, however, assume a more complicated shape and are not expressed by the form described above. Also, when the transmission of the electronic signature alone is desired separately from the message, the description thereof is impossible. In view of this, according to this embodiment, the description as shown in FIG. 6 is used to improve the description ability of the cryptographic protocol specification description language.

In the case of FIG. 6, the definition part defines that the signature function (SIGN FUNCTION) is Sig, the verification function (VERIFY FUNCTIONS) is Ver and the key generation function (GENKEYS FUNCTIONS) is G. In the description of the definition part,
Sig WITH KS ISVERIFIEDBY Ver WITH KV SUCHTHAT (KS;;KV)=G ( ); (1)

The description in equation (1) indicates that the key generation function G ( ) generates a pair of the signature key KS and the verification key KV (KS ;; KV). The definition part shown in FIG. 6, therefore, defines that the key generation function G ( ) generates the pair (KₛA ;; KᵥA) of the signature key KₛA and the verification key KᵥA and that the key generation function G ( ) also generates the pair (KₛB ;; KᵥB) of the signature key KₛB and the verification key KᵥB.

Incidentally, in the case of FIG. 6, the key generation function G is a function having no argument. As an alternative, the key generation function G may have a security or other parameters as an argument. Also, the key generation function G may be configured as a function of probability as well as a function of determinability. When the key generation function is configured as a function of probability, a key pair selected at random from the space of the key pairs as a whole is generated each time the key generation function G is accessed.

The specification description in the initial condition part, the protocol execution definition part and the goal part is defined as follows:

<x>Sig(k): The signature of the message x by the signature function Sig, where k is a signature key.

VerificationKey PVK: The verification key of the verification algorithm V of the signature by the party P is K.

A Believes <Stmt>: There was the ground for the party A to believe <Stmt>.

A Possesses <Stmt>: The party A has received <Stmt> or can calculate <Stmt> from a plurality of the received <Stmt>.

A Received <Stmt>: The party A has received <Stmt> before the execution of the current protocol or has received it as a given message or a part received before the execution of the present protocol.

A Conveyed <Stmt>: The party A is a generator and a source during the execution of the current protocol of <Stmt>.

In FIG. 6, therefore, the initial condition part indicates the following:

The party A has received the signature function Sig, the verification function Ver and the signature key KₛB before execution of the current protocol or as a message or a part thereof received before execution of the current protocol.

The party A has received the signature key KₛA.

There is a ground for the party A to believe that the verification key of the verification algorithm Ver of the signature by the party B is KₛB.

The party B has received the signature function Sig, the verification function Ver and the signature key KₛA before execution of the current protocol or as a message or a part thereof received before execution of the current protocol.

The party B has received the signature key KₛB.

There is a ground for the party B to believe that the verification key of the verification algorithm Ver of the signature by the party A is KₛA.

Also, in FIG. 6, the protocol execution definition part indicates the following meaning, where the number at the extreme left of FIG. 6 indicates the stage of execution.

Stage 1: The message NoB is transmitted from B to A.

Stage 2: The messages NoA, NoB, B and the signatures of the messages NoA, NoB, B by the signature function Sig (signature key KₛA) are transmitted from A to B.

Stage 3: The messages NoB2, NoA, A and the signatures (signature key KₛB) of the messages NoB2, NoA, A by the signature function Sig are transmitted from B to A.

Also, in FIG. 6, the goal part indicates the following:

Stage 1: There is a ground for B to believe that A is a generator and a source, during the execution of the current protocol, of the signatures (signature key KₛA) of the messages NoA, NoB, B by the signature function Sig.

Stage 2: There is a ground for A to believe that B is a generator and a source, during the execution of the current protocol, of the signatures (signature key KₛB) of the messages NoB2, NoA, A by the signature function Sig.

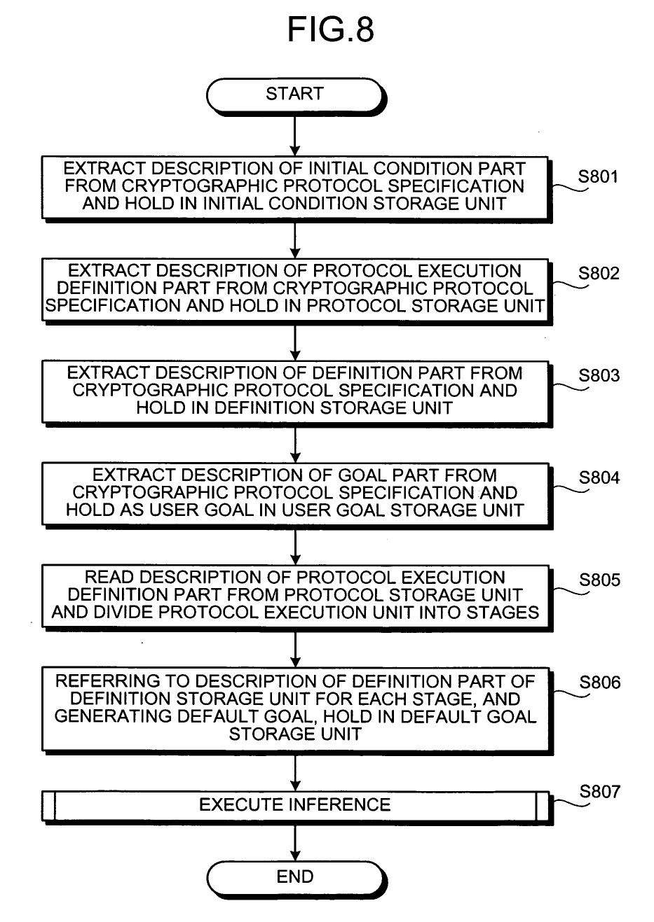

FIG. 7A is a diagram for explaining an example of the description using the ideal functionality in the cryptographic protocol specification. FIG. 7A shows the protocol of signature and the protocol of verification in the protocol execution definition part. In FIG. 7A, P indicates a party actually involved in the execution of the protocol, F the ideal functionality and S a simulator (adversary).

The signature protocol indicates the following:

Stage 1: A signature request is transmitted from the party P to the ideal functionality F.

Stage 2: A signature request is transmitted from the ideal functionality F to the simulator S.

Stage 3: A signature is transmitted from the simulator S to the ideal functionality F.

Stage 4: A signature is transmitted from the ideal functionality F to the party P.

The verification protocol indicates the following:

Stage 1: A verification request is transmitted from the party P to the ideal functionality F.

Stage 2: A verification request is transmitted from the ideal functionality F to the simulator S.

Stage 3: A verification is transmitted from the simulator S to the ideal functionality F.

Stage 4: A verification is transmitted from the ideal functionality F to the party P.

The protocol specification shown in FIG. 7A contains the description of the simulator S, while the verifiable cryptographic protocol specification according to this embodiment has added thereto the entity of the ideal functionality from the description in the UC, and the description of the simulator as an attacker is deleted or the description of the ideal functionality is substituted. Specifically, the cryptographic protocol specification having the second storage unit 502 is introduced wherein the information utilizable at the time of attack is substituted for the information exchanged between the simulator S and the ideal functionality F, and the description of the immediate distribution by the ideal functionality is substituted for the description of the request for immediate distribution from the ideal functionality to the simulator.

FIG. 7B is a diagram for explaining an example of the protocol execution definition part of the second description section 502 of the verifiable cryptographic protocol specification data 500. FIG. 7B shows the signature protocol and the verification protocol in which the description of the simulator S is substituted as described above in the description of the protocol execution definition part of FIG. 7A. That is, the description of the immediate signature by the ideal functionality is substituted for the signature request from the ideal functionality F to the simulator S in the signature protocol in FIG. 7A, as follows:

Stage 1: A signature request is transmitted from the party P to the ideal functionality F.

Stage 2: A signature is transmitted from the ideal functionality F to the party P.

In similar fashion, the verification protocol indicates the following:

Stage 1: A verification request is transmitted from the party P to the ideal functionality F.

Stage 2: A verification is transmitted from the ideal functionality F to the party P.

As described above, according to this embodiment, the cryptographic protocol specification including the second description section 502 with the description on the simulator S deleted therefrom is input to verify the security of the cryptographic protocol.

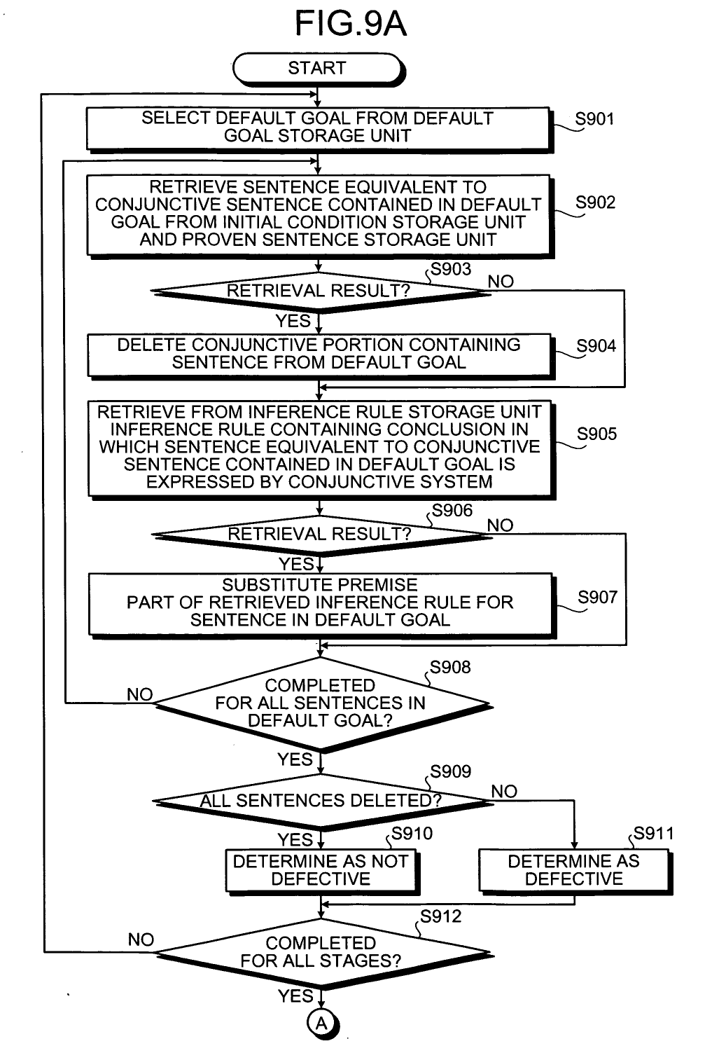

Next, the process of verifying the security of the cryptographic protocol by the cryptographic protocol security verification apparatus according to this embodiment having the configuration described above is explained. FIG. 8 is a flowchart showing the procedures of the process for verifying the security of the cryptographic protocol according to the first embodiment.

The verifiable cryptographic protocol specification data 500 having the first description section 501 as shown in FIG. 6 and the second description section 502 as shown in FIG. 7B is input by the cryptographic protocol specification input processing unit 110, after which the cryptographic protocol specification data is analyzed by the analysis unit 121 of the formal verification unit 120 and the description of the initial condition part is extracted from the cryptographic protocol specification data and stored in the initial condition storage unit 141 (step S801). Then, the description of the protocol execution definition part is extracted from the cryptographic protocol specification data by the analysis unit 121 and stored in the protocol storage unit 142 (step S802). In similar fashion, the description of the definition part is extracted from the cryptographic protocol specification data by the analysis unit 121 and stored in the definition storage unit 143 (step S803). Further, the description of the goal part is extracted from the cryptographic protocol specification data by the analysis unit 121 and stored as a user goal in the user goal storage unit 144 (step S804). Incidentally, the process of step S804 is not executed for the verifiable cryptographic protocol specification data 500 having no goal part.

Next, the description of the protocol execution definition part is read from the protocol storage unit 142 and divided into the sentences of each stage by the analysis unit 123 (step S805). Each stage is composed of a single sentence in the case of FIGS. 6 and 7A and may alternatively be composed of a plurality of sentences. While referring to the description of the definition part stored in the definition storage unit 143, the default goal of inference is generated for each stage and stored in the default goal storage unit 145 (step S806).

The inference is carried out by the inference execution unit 122 from the default goal, the user goal, the proven sentence storage unit 152 and the inference rule of the inference rule storage unit 151 thereby to verify the security of the cryptographic protocol specification (step S807). As the result of verification, the signals indicating whether cryptographic protocol specification is safe or not, whether each stage of the protocol execution definition part has a defect or not and whether the goal part has a defect or not are output to a display unit or the like by the verification result output unit 130.

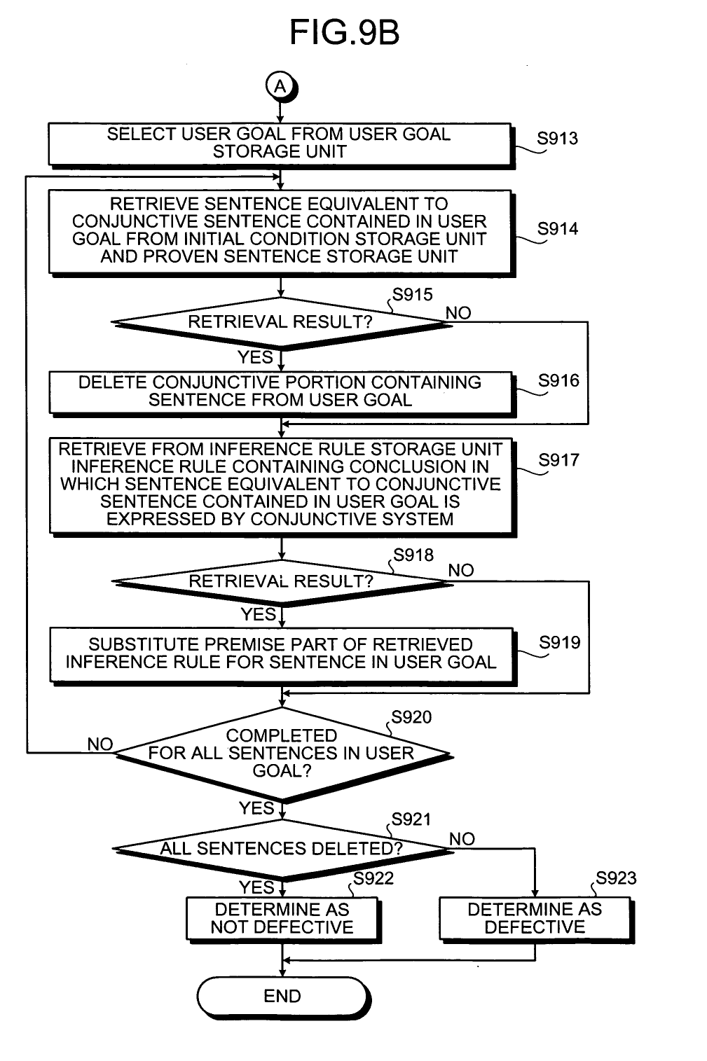

Next, the inference execution process by the inference execution unit 122 at step S807 is explained. FIGS. 9A and 9B are flowcharts showing the procedures of the inference execution process by the inference execution unit 122. Although the backward inference is carried out according to this embodiment, the forward inference can alternatively be performed to prove the security.

Each default goal is generally expressed in the form of disjunctive sentence (sentence expressed by the logic sum) of several conjunctive sentences (sentence expressed by the logic product). First, the inference execution unit 122 selects one default goal from the default goal storage unit 145 (step S901). The sentence equivalent to the conjunctive sentence contained in the selected default goal is retrieved from the initial condition storage unit 141 and the proven sentence storage unit 152 (step S902). The sentence equivalent to the conjunctive sentence contained in the default goal is defined as the same sentence as the conjunctive sentence contained in the default goal and a sentence equalized by substituting a value into the variable in the conjunctive sentence contained in the default goal.

In the presence of the retrieval result, i.e. when the sentence equivalent to the conjunctive sentence contained in the selected default goal is existent in the initial condition storage unit 141 or the proven sentence storage unit 152 (YES at step S903), the conjunctive portion containing the retrieved sentence is deleted from the selected default goal (step S904). In the absence of the retrieval result at step S903, i.e. when the sentence equivalent to the one in conjunctive sentence contained in the selected default goal is existent in neither the initial condition storage unit 141 nor the proven sentence storage unit 152 (NO at step S903), on the other hand, no sentence is deleted from the default goal.

Next, the inference rule containing the conclusion in which the sentence equivalent to the conjunctive sentence contained in the default goal is expressed in conjunctive form is retrieved from the inference rule storage unit 151 by the inference execution unit 122 (step S905). The inference rule is assumed to be stored in the inference rule storage unit with the conclusion thereof expressed in conjunctive form. In the presence of the retrieval result, i.e. when the inference rule including the conclusion in which the sentence equivalent to the conjunctive sentence contained in the default goal is existent in the inference rule storage unit 151 (YES at step S906), the premise part of the inference rule retrieved is substituted for the particular sentence of the default goal (step S907). In the absence of the retrieval result at step S906, i.e. when the inference rule containing the conclusion expressed in conjunctive form in which the sentence equivalent to the conjunctive sentence contained in the default goal is not existent in the inference rule storage unit 151 (NO at step S906), on the other hand, the premise part is not substituted.

The process of steps S902 to S907 is executed for all the sentences in the default goal (step S908). Once the process of steps S902 to S907 has been executed for all the sentences in the default goal, step S904 determines whether all the sentences in the default goal are deleted or not (step S909).

When all the sentences in the default goal are deleted (YES at step S909), it is determined that the default goal is not defective (step S910). When all the sentences of the default goal are not deleted (NO at step S909), on the other hand, it is determined that the default goal is defective (step S911). The process of steps S901 to S910 or S911 is executed for all the stages of the protocol execution definition part of the verifiable cryptographic protocol (step S912).

Next, the inference execution unit 122 selects the user goal (i.e. the description of the goal part) from the user goal storage unit 144 (step S913). Each user goal is also expressed in the disjunctive form (sentence expressed by the logic sum) of several conjunctive sentences (sentences expressed by the logic product). The sentence equivalent to the conjunctive sentence contained in the selected user goal is retrieved from the initial condition storage unit 141 and the proven sentence storage unit 152 (step S914).

In the presence of the retrieval result, i.e. when the sentence equivalent to the conjunctive sentence contained in the selected user goal is existent in the initial condition storage unit 141 or the proven sentence storage unit 152 (YES at step S915), the conjunctive portion containing the sentence retrieved from the selected user goal is deleted (step S916). In the absence of the retrieval result at step S915, i.e. when the sentence equivalent to the conjunctive sentence contained in the selected user goal is stored in neither the initial condition storage unit 141 nor the proven sentence storage unit 152 (NO at step S915), on the other hand, no sentence is deleted from the user goal.

Next, in the inference execution unit 122, the inference rule including the conclusion in which the sentence equivalent to the conjunctive sentence contained in the user goal is expressed in conjunctive form is retrieved from the inference rule storage unit 151 (step S917). In the presence of the retrieval result, i.e. when the inference rule containing the conclusion in which the sentence equivalent to the conjunctive sentence contained in the user goal is expressed in conjunctive form is existent in the inference rule storage unit 151 (YES at step S918), the premise part of the retrieved inference rule is substituted for the particular sentence of the user goal (step S919). In the process, the same value is substituted into the same variable of the conclusion part.

In the absence of the retrieval result at step S918, i.e. when the inference rule containing the conclusion in which the sentence equivalent to the conjunctive sentence contained in the user goal is expressed in conjunctive form is not existent in the inference rule storage unit 151 (NO at step S918), no substitution is made.

The process of steps S914 to S919 is executed for all the sentences in the user goal (step S920). Once the process of S914 to S919 has been executed for all the sentences in the user goal, step S916 determines whether all the sentences in the user goal have been deleted or not (step S921).

When all the sentences in the user goal have been deleted (YES at step S921), it is determined that the user goal is not defective (step S922). When all the sentences in the user goal are not deleted (NO at step S921), on the other hand, it is determined that the particular user goal is defective (step S923). In this case, the inference rule may be changed and a similar process may be repeated.

With this inference by the inference execution unit 122 utilizing the default goal described above, the presence or absence of a defect in the description of the protocol execution definition part of the verifiable cryptographic protocol specification data 500 is determined, i.e. the security verification is carried out. With the inference utilizing the user goal, on the other hand, the presence or absence of a defect in the description of the goal part of the verifiable cryptographic protocol specification data 500 is determined, i.e. the security verification is carried out. In the case of the verifiable cryptographic protocol specification data 500 having no goal part, the process of steps S913 to S922 or S923 for the user goal is not executed.

As the result of verification with the inference by the inference execution unit 122, the verification result as to whether the cryptographic protocol specification is safe or not, whether each stage of the protocol execution definition part has a defect or not and whether the goal part is defective or not is output to a display unit or the like by the verification result output unit 130. When no defect exists in all the stages of the protocol execution definition part and the goal part has no defect, the security of the cryptographic protocol specification is proved.

In the cryptographic protocol specification security verification apparatus 100 according to the first embodiment, the security of the verifiable cryptographic protocol containing an entity of the ideal functionality defined by the universal composability and having no description of a simulator as an attacker is verified by the formal verification unit 120. Thus, after matching between the cryptographic protocol specification in the metric proof and the cryptographic protocol specification in the formal verification, the primitive security is secured by the metric proof while at the same time saving the labor of security verification by the mechanical verification process based on the formal verification of a complicated cryptographic protocol.

Next, a second embodiment is explained.

The cryptographic protocol security verification apparatus 100 according to the first embodiment verifies the security of the cryptographic protocol by being supplied with the cryptographic protocol specification data having the first description section 501 shown in FIG. 6 and the second description section 502 shown in FIG. 7B, i.e. the verifiable cryptographic protocol specification data. In the cryptographic protocol security verification apparatus according to the second embodiment, on the other hand, the verifiable cryptographic protocol specification data 500 is generated from the input cryptographic protocol specification data and the security of the verifiable cryptographic protocol specification data 500 thus generated is verified.

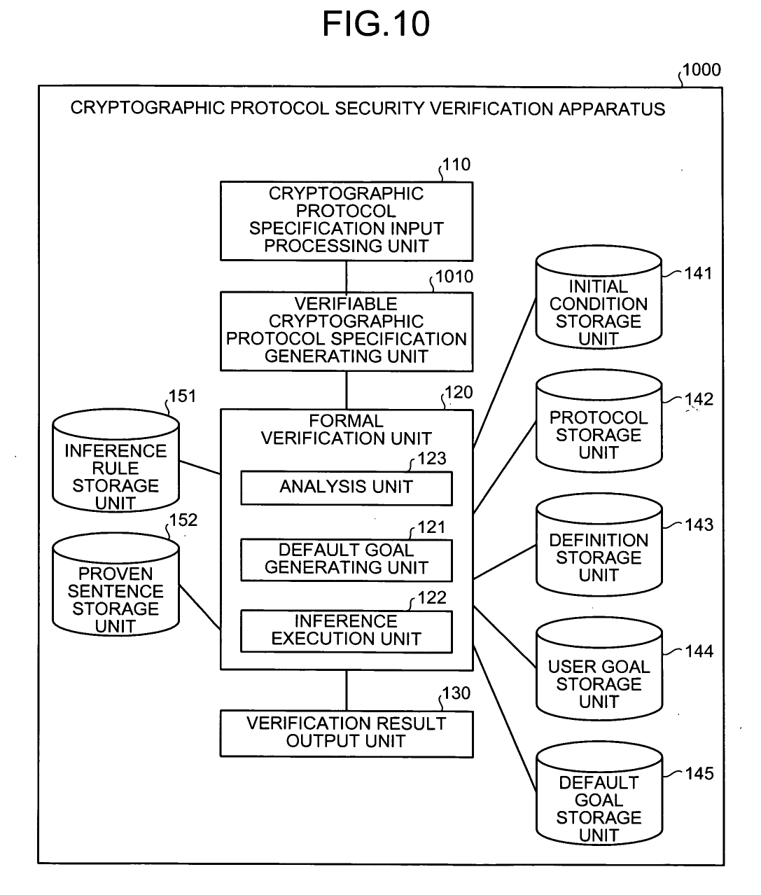

FIG. 10 is a block diagram showing a functional configuration of a cryptographic protocol security verification apparatus according to the second embodiment. The cryptographic protocol security verification apparatus 1000 according to this embodiment, as shown in FIG. 10, mainly comprises a cryptographic protocol specification input processing unit 110, a verifiable cryptographic protocol specification generating unit 1010, a formal verification unit 120, a verification result output unit 130, an initial condition storage unit 141, a protocol storage unit 142, a definition storage unit 143, a user goal storage unit 144, a default goal storage unit 145, an inference rule storage unit 151 and a proven sentence storage unit 152.

Here, the formal verification unit 120, the verification result output unit 130, the initial condition storage unit 141, the protocol storage unit 142, the definition storage unit 143, the user goal storage unit 144, the default goal storage unit 145, the inference rule storage unit 151 and the proven sentence storage unit 152 have the same configuration and the same functions as the corresponding component elements, respectively, of the cryptographic protocol security verification apparatus 100 according to the first embodiment.

The cryptographic protocol specification input processing unit 110 is a processing unit for inputting the cryptographic protocol specification data. The cryptographic protocol specification data input includes a first description section 501 described in the protocol specification of the formal verification (FV) and a second description section described in the protocol specification in the UC of the metric proof, and is different from the verifiable cryptographic protocol specification data 500 input in the first embodiment in that the second description section of UC is not matched with the formal verification.

The verifiable cryptographic protocol specification generating unit 1010 is a processing unit for generating the verifiable cryptographic protocol specification data 500 from the cryptographic protocol specification data input by the cryptographic protocol specification input processing unit 110. The verifiable cryptographic protocol specification data 500, like in the first embodiment, is the cryptographic protocol specification including the first description section 501 described in the protocol specification of the formal verification (FV) and the second description section 502 described based on the protocol specification of UC (universal composability) of the metric proof, wherein the specification in UC and the specification in metric proof are matched with each other.

Specifically, in the verifiable cryptographic protocol specification generating unit 1010, the entity of the ideal functionality is added from the description in the UC of the second description section of the cryptographic protocol specification data input, and after deleting the description of the simulator as an attacker and substituting the description of the ideal functionality, the verifiable cryptographic protocol specification data 500 is generated while matching between the specification of UC and the specification in formal proof. Also in this embodiment, an example of the verifiable cryptographic protocol specification data 500, like in the first embodiment, is the description shown in FIG. 6 for the first description section 501 and the description shown in FIG. 7B for the second description section 502. Also in this embodiment, the verifiable cryptographic protocol specification data 500, like in the first embodiment, is described by being divided into the initial condition part, the definition part, the protocol execution definition part and the goal part.

Next, the cryptographic protocol security verification process executed by the cryptographic protocol security verification apparatus 1000 according to this embodiment configured as describe above is explained.

Once the cryptographic protocol specification data having the first description section 501 shown in FIG. 6 and the second description section 502 shown in FIG. 7A is input by the cryptographic protocol specification input processing unit 110, the verifiable cryptographic protocol specification generating unit 1010 generates the verifiable cryptographic protocol specification data 500 having the first description section 501 shown in FIG. 6 and the second description section 502 shown in FIG. 7B from the input verifiable protocol specification data. The security of the cryptographic protocol of this generated verifiable cryptographic protocol specification data 500 is verified by the formal verification unit 120, and the verification result is output by the verification result output unit 130.

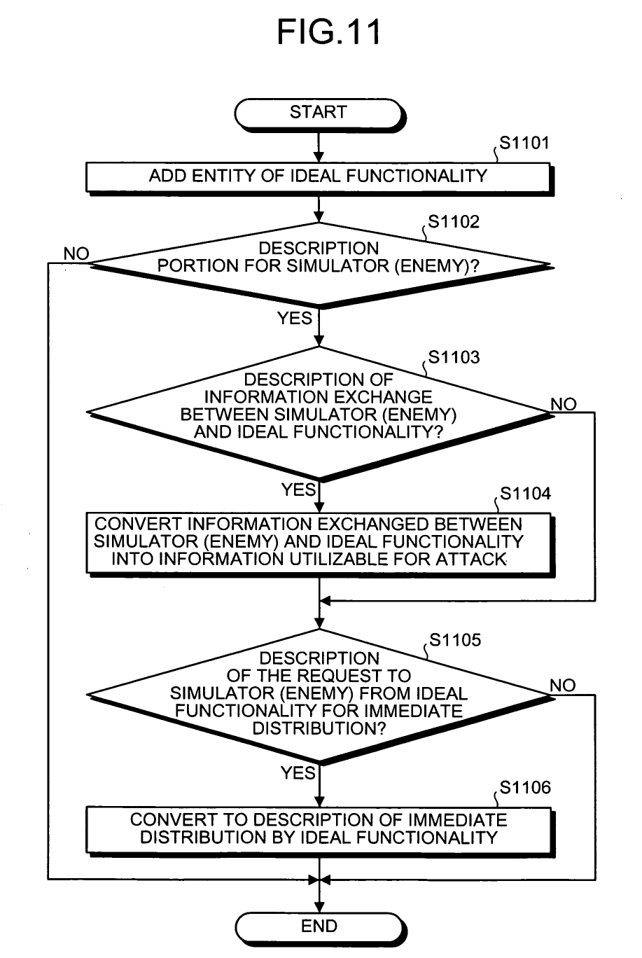

Next, about the process of generating the verifiable cryptographic protocol specification data 500 by the verifiable cryptographic protocol specification generating unit 1010 is explained. FIG. 11 is a flowchart showing the procedures of the process for generating the verifiable cryptographic protocol specification data 500 by the verifiable cryptographic protocol specification generating unit 1010.

First, the verifiable cryptographic protocol specification generating unit 1010 adds the description of the entity of the ideal functionality of the second description section (step S1101). When the ideal functionality exists in the second description section from the beginning, however, the process of step 1101 is not executed. The verifiable cryptographic protocol specification generating unit 1010 checks whether the second description section contains a description portion concerning the simulator (adversary) S or not (step S1102). In the absence of the description portion concerning the simulator (adversary) S (NO at step 1102), the process is terminated as it is.

In the presence of the description portion concerning the simulator (adversary) S (YES at step 1102), on the other hand, the verifiable cryptographic protocol specification generating unit 1010 further checks whether the second description section contains the description of information exchange between the simulator (adversary) S and the ideal functionality or not (step S1103). When the description of information exchange between the simulator (adversary) S and the ideal functionality is contained in the second description section (YES at step S1103), the verifiable cryptographic protocol specification generating unit 1010 converts the information exchanged between the simulator (adversary) S and the ideal functionality as information utilizable for attack (step S1104). In the absence of the description of information exchange between the simulator (adversary) S and the ideal functionality (NO at step S1103), on the other hand, the process of step S1104 is not executed.

Next, the verifiable cryptographic protocol specification generating unit 1010 checks whether the second description section contains the description that the simulator (adversary) S is requested to immediately distribute the message to the party from the ideal functionality (step S1105). When the second description section contains the description that the simulator (adversary) S is requested to immediately distribute the message to the party from the ideal functionality (YES at step S1105), this description is converted into the description of immediate distribution of the message to the party from the ideal functionality (step S1106). In the absence of the description that the simulator (adversary) S is requested to immediately distribute the message to the party from the ideal functionality (NO at step S1105), on the other hand, the process of step S1106 is not executed.

By the process described above, the verifiable cryptographic protocol specification data 500 is generated by the formal verification unit 120 as shown in FIGS. 6 and 7A from the input cryptographic protocol specification data. The process of verifying the security of the verifiable cryptographic protocol specification data 500 thus generated is executed in a similar manner to the process explained with reference to FIGS. 8, 9A and 9B in the first embodiment, and the verification result, like in the first embodiment, is output to a display unit by the verification result output unit 130.

In the cryptographic protocol security verification apparatus 1000 according to the second embodiment, as described above, the verifiable cryptographic protocol specification data 500 is generated from the cryptographic protocol specification data input, and the security of the verifiable cryptographic protocol specification data 500 generated is verified. While the user is unconscious about the matching between the cryptographic protocol specification in the metric proof and the cryptographic protocol specification in the formal verification, therefore, the primitive security is secured by the metric proof while at the same time reducing the labor of security verification by the mechanical formal verification process for the complicated cryptographic protocol.

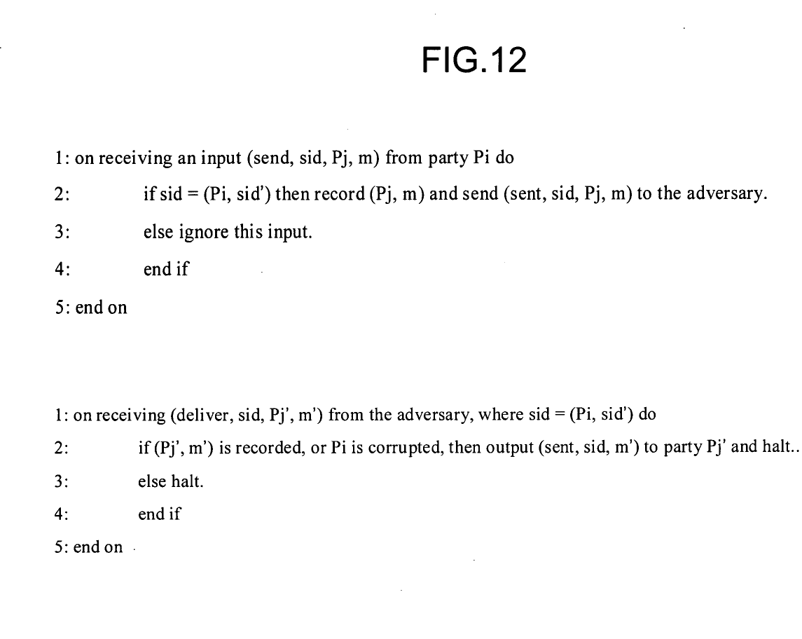

A UC formulation exists in which the message between the party involved actually in the execution of the cryptographic protocol and the ideal functionality cannot be recognized by the simulator. FIG. 12, for example, shows the ideal functionality F_{AUTH} of the authenticated communication path defined by the formulation according to a modification of the second embodiment. This ideal functionality executes the following process:

Upon receipt of a message (send, sid, Pj, m) from a given party Pi, it is determined whether “sid” assumes the form of (Pj, sid′) or not. When “sid” assumes the form of (Pj, sid′), (Pj, m) is recorded and (send, sid, Pj, m) is transmitted to the attacker/simulator. When “sid” assumes no form of (Pj, sid′), on the other hand, the ideal functionality ignores this input.

The ideal functionality, on the other hand, upon receipt of the message (deliver, sid, Pj′, m′) in the form of sid=(Pi, sid′) from the attacker/simulator, determines whether (Pi′, m′) is recorded or not or whether Pi is corrupted or not, and if so, stops the output of (sent, sid, m′) to the party Pj′. Otherwise, the output is simply stopped.

In this case, the message is distributed to the party from the ideal functionality itself. Before distribution, however, the ideal functionality notifies the attacker/simulator of the contents of the proposed notification. In response to this notification, the simulator is given the chance of changing the party constituting the message destination or altering the contents of the message. When the alteration or the change is made, the ideal functionality distributes the message accordingly. Specifically, the ideal functionality seeks the permission thereof from the simulator before the message distribution and is required to distribute the message in accordance with the permission of the simulator.

In the verifiable cryptographic protocol specification generating means 1010 in this modification, with regard to the second description section corresponding to the ideal functionality described above, the description that the distribution is made by the ideal functionality without requesting the permission from the simulator is substituted for the description that the ideal functionality distributes the message to the party after seeking the distribution permission of the simulator. While the information utilizable at the time of attack is substituted for the information exchanged between the ideal functionality and the simulator.

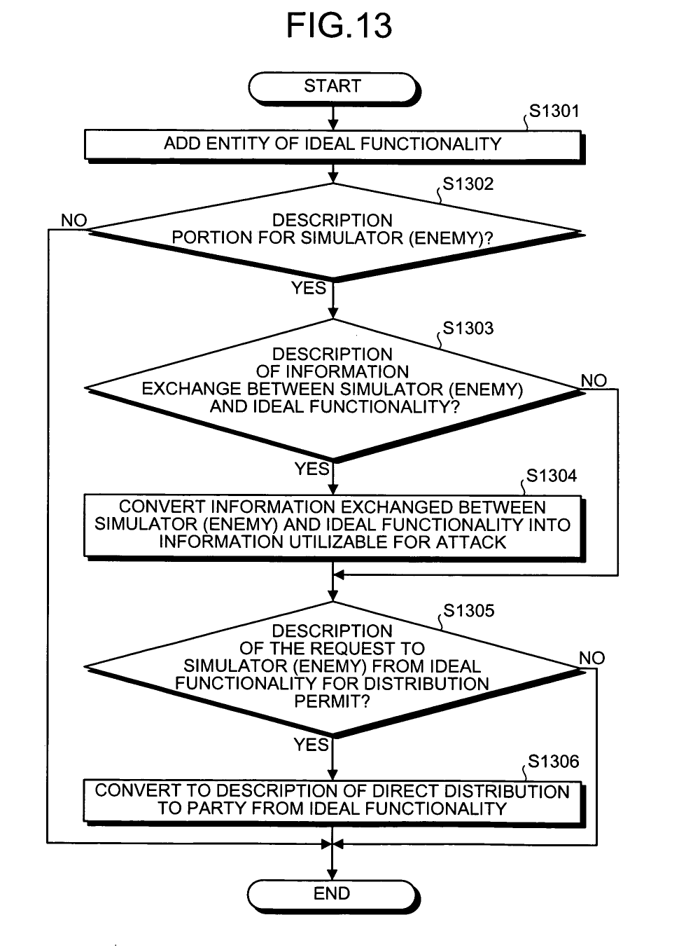

Next, the process of generating the verifiable cryptographic protocol specification data 500 by the verifiable cryptographic protocol specification generating unit 1010 is explained. FIG. 13 is a flowchart showing the procedures of the process for generating the verifiable cryptographic protocol specification data 500 by the verifiable cryptographic protocol specification generating unit 1010 according to a modification of the second embodiment.

First, the verifiable cryptographic protocol specification generating unit 1010 adds the description of the entity of the ideal functionality to the second description section (step S1301). When the description of the ideal functionality exists in the second description section from the beginning, this step S1301 is not executed. The verifiable cryptographic protocol specification generating unit 1010 checks whether the second description section contains the description portion concerning the simulator (adversary) S (step S1302). In the absence of the description portion concerning the simulator (adversary) S (NO at step S1302), the process is terminated as it is.

In the presence of the description portion concerning the simulator (adversary) S (YES at step S1302), on the other hand, the verifiable cryptographic protocol specification generating unit 1010 further checks whether the second description section contains the description of information exchange between the simulator (adversary) S and the ideal functionality (step S1303). In the presence of the description of information exchange between the simulator (adversary) S and the ideal functionality (YES at step S1303), the verifiable cryptographic protocol specification generating unit 1010 converts the information exchanged between the simulator (adversary) S and the ideal functionality as information utilizable for attack (step S1304). In the absence of the description of information exchange between the simulator (adversary) S and the ideal functionality (NO at step S1303), on the other hand, the process of step S1304 is not executed.

Next, the verifiable cryptographic protocol specification generating unit 1010 checks whether the second description section contains the description that the simulator (adversary) S is requested or not to permit the message distribution to the party from the ideal functionality (step S1305). In the presence of the description that the simulator (adversary) S is requested to permit the message distribution to the party from the ideal functionality (YES at step S1305), this description is converted to the description that the message is distributed directly to the party without requesting the permission from the ideal functionality (step S1306). In the absence of the description that the simulator (adversary) S is requested to permit the message distribution to the party from the ideal functionality (NO at step S1305), on the other hand, the process of step S1306 is not executed.

As described above, in the cryptographic protocol security verification apparatus 1000 according to a modification of the second embodiment, the verifiable cryptographic protocol specification data 500 is generated from the cryptographic protocol specification data including the formulation UC indicating that the simulator cannot recognize the message exchanged between the party actually involved in the execution of the cryptographic protocol and the ideal functionality thereby to verify the security of the verifiable cryptographic protocol specification data 500 generated. Thus, the labor of security verification can be saved by the mechanical verification process using the formal verification on a complicated cryptographic protocol while at the same time securing the primitive security by metric proof without rendering the user conscious of the matching between the cryptographic protocol specification in the metric proof and the cryptographic protocol specification in the formal verification.

Next, a third embodiment is explained.

The third embodiment represents a cryptographic protocol design apparatus for designing a cryptographic protocol using the verifiable cryptographic protocol specification generating means and the formal verification means described in the first and second embodiments.

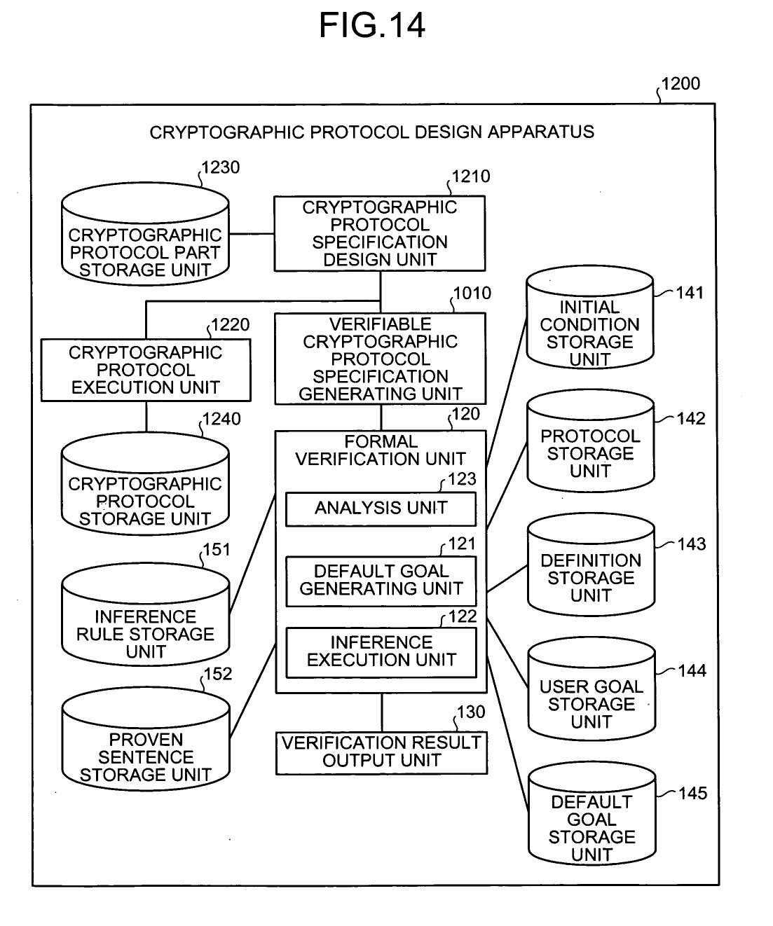

FIG. 14 is a block diagram showing a functional configuration of a cryptographic protocol design apparatus according to the third embodiment. The cryptographic protocol design apparatus 1200 according to this embodiment mainly includes, as shown in FIG. 14, a cryptographic protocol specification design unit 1210, a verifiable cryptographic protocol specification generating unit 1010, a formal verification unit 120, a verification result output unit 130, a cryptographic protocol execution unit 1220, an initial condition storage unit 141, a protocol storage unit 142, a definition storage unit 143, a user goal storage unit 144, a default goal storage unit 145, an inference rule storage unit 151, a proven sentence storage unit 152, a cryptographic protocol part storage unit 1230 and a cryptographic protocol storage unit 1240.

Here, the verifiable cryptographic protocol specification generating unit 1010, the formal verification unit 120, the verification result output unit 130, the initial condition storage unit 141, the protocol storage unit 142, the definition storage unit 143, the user goal storage unit 144, the default goal storage unit 145, the inference rule storage unit 151 and the proven sentence storage unit 152 have a similar configuration and a similar function to the corresponding component elements, respectively, of the cryptographic protocol security verification apparatus 100 according to the first embodiment.

The cryptographic protocol part storage unit 1230 is a storage medium such as a HDD or a memory for storing the component parts of the cryptographic protocol specification data. The cryptographic protocol part storage unit 1230 has specifically stored therein a first description part constituting the first description section 501 described in the protocol specification in the formal verification (FV) and a second description part constituting the second description section described in the protocol specification in the metric proof of UC. The sentences and the phrases constituting the specification description shown in FIG. 6 explained in the first embodiment are an example of the first description part. Also, the sentences and the phrases constituting the specification description shown in FIG. 7A not matched with the specification in the formal verification are an example of the second description part.

The cryptographic protocol specification design unit 1210 is a processing unit for reading the first description part and the second description part stored in the cryptographic protocol part storage unit 1230 and generating a cryptographic protocol specification data from the first and second description parts that have been read. Specifically, the cryptographic protocol specification design unit 1210 reads the first and second description parts designated by the user from the cryptographic protocol part storage unit 1230, and by combining the first and second description parts as designated by the user or arbitrarily thereby to generate the description of a cryptographic protocol specification data. From the cryptographic protocol specification data generated in this way, the verifiable cryptographic protocol specification data 500 with the second description section matched with the formal verification (FV) is generated by the cryptographic protocol specification generating unit 1010 as shown in FIG. 7B, for example, thereby verifying the security through the formal verification unit 120. Also, the cryptographic protocol specification data thus generated is delivered also to the cryptographic protocol execution unit 1220.

The cryptographic protocol execution unit 1220 is a processing unit for generating a executable cryptographic protocol in accordance with the designation input of the user from the verifiable cryptographic protocol specification data 500 of which the security is proven by the formal verification unit 120 and storing the generated executable cryptographic protocol in the cryptographic protocol storage unit 1240.

The cryptographic protocol storage unit 1240 is a storage medium such as a HDD or a memory for storing the executable cryptographic protocol generated by the cryptographic protocol execution unit 1220.

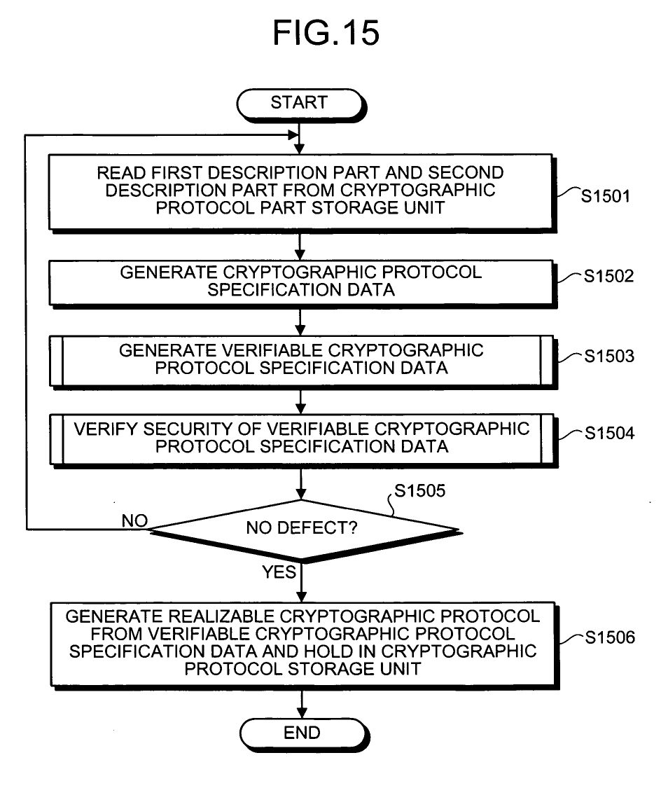

Next, the process of designing the cryptographic protocol by the cryptographic protocol design apparatus 1200 according to this embodiment having the above-mentioned configuration is explained. FIG. 15 is a flowchart showing the procedures of the cryptographic protocol design process executed by the cryptographic protocol design apparatus 1200.

First, the cryptographic protocol specification design unit 1210 reads the first and second description parts required for generation from the cryptographic protocol part storage unit 1230 as designated by the user (step S1501). The cryptographic protocol specification design unit 1210 then generates a cryptographic protocol specification data by combining, as designated by the user, the first and second description parts that have been read (step S1502).

Next, the verifiable cryptographic protocol specification data 500 is generated from the generated cryptographic protocol specification data by the verifiable cryptographic protocol specification generating unit 1010 (step S1503). The process of generating the verifiable cryptographic protocol specification data 500 by the verifiable cryptographic protocol specification generating unit 1010 is executed in the same manner as in the second embodiment described with reference to FIG. 11. That is, the entity of the ideal functionality is added from the description in the UC of the second description section of the cryptographic protocol specification data, and the description of the simulator as an attacker is deleted thereby to substitute the description for the ideal functionality [the description of information exchange between the simulator (adversary) S and the ideal functionality is converted as information utilizable for attacking the information exchanged between the simulator (adversary) S and the ideal functionality, and the description which the simulator (adversary) S is requested to immediately distribute from the ideal functionality is converted to the description immediately distributed by the ideal functionality]. In this way, the verifiable cryptographic protocol specification data 500 described while matching between the specification in UC and the specification in the formal proof is generated.

Once the verifiable cryptographic protocol specification data 500 is generated, the security of the verifiable cryptographic protocol specification data 500 is verified by the formal verification unit 120 (step S1504). The process of security verification of the verifiable cryptographic protocol specification data 500 is executed by the formal verification unit 120 in the same manner as in the first and second embodiments described above with reference to FIGS. 8, 9A and 9B.

Upon completion of the security verification process by the formal verification unit 120, the verification result output unit 130 outputs the verification result and determines whether the absence of a defect in the verifiable cryptographic protocol specification data 500 has been proven by the formal verification unit 120 or not, i.e. whether the security has been proven or not (step S1505). When the verifiable cryptographic protocol specification data 500 has a defect (NO at step S1505), the process of steps S1501 to S1504 is repeated.

When the verifiable cryptographic protocol specification data 500 has proved to be not defective at step S1505, i.e. when the security has been proven (YES at step S1505), on the other hand, an executable cryptographic protocol is generated as designated by the user from the verifiable cryptographic protocol specification data 500 through the cryptographic protocol execution unit 1220 and held in the cryptographic protocol storage unit 1240 (step S1506). As a result, the cryptographic protocol of which the security has been proven is designed.

As described above, in the cryptographic protocol design apparatus 1200 according to the third embodiment, the cryptographic protocol specification data is generated from the first and second description parts, and the verifiable cryptographic protocol containing the entity for the ideal functionality defined by the universal composability proof from the generated cryptographic protocol specification data and containing no description of the simulator as an attacker is generated and the security thereof is verified. Based on the cryptographic protocol specification data of which the security has been proven, a realizable cryptographic protocol is generated. Thus, after matching between the cryptographic protocol specification in the metric proof and the cryptographic protocol specification in the formal verification, the primitive security is secured by metric proof, while at the same time saving the labor of security verification by the mechanical verification process based on the formal verification of a complicated cryptographic protocol, thereby making it possible to design an accurate cryptographic protocol.

The cryptographic protocol security verification apparatus according to the first and second embodiments and the cryptographic protocol design apparatus according to the third embodiment have a hardware configuration utilizing a normal computer and include a control unit such as a CPU, a storage unit such as a ROM (read-only memory) or a RAM, an external storage unit such as a CD drive or a HDD and a display unit such as a display and an input unit such as a keyboard and a mouse.

The cryptographic protocol security verification program executed by the cryptographic protocol security verification apparatus according to the first and second embodiments and the cryptographic protocol design program executed by the cryptographic protocol design apparatus according to the third embodiment are provided in the form recorded in a computer readable storage medium such as the CD-ROM, flexible disk (FD), CD-R, DVD (digital versatile disk) in a file having an installable or executable format.

Also, the cryptographic protocol security verification program executed by the cryptographic protocol security verification apparatus according to the first and second embodiments and the cryptographic protocol design program executed by the cryptographic protocol design apparatus according to the third embodiment may be stored in a computer connected to a network such as the Internet and supplied by being downloaded through the network. Further, the cryptographic protocol security verification program executed by the cryptographic protocol security verification apparatus according to the first and second embodiments and the cryptographic protocol design program executed by the cryptographic protocol design apparatus according to the third embodiment may be supplied or distributed through a network such as the Internet.

Still Further, the cryptographic protocol security verification program executed by the cryptographic protocol security verification apparatus according to the first and second embodiments and the cryptographic protocol design program executed by the cryptographic protocol design apparatus according to the third embodiment may be incorporated in a ROM or the like in advance and supplied.

The cryptographic protocol security verification program executed by the cryptographic protocol security verification apparatus according to the first and second embodiments is configured of modules including the aforementioned units (the cryptographic protocol specification input processing unit 110, the verifiable cryptographic protocol specification generating unit 1010, the formal verification unit 120, the verification result output unit 130). As an actual hardware, the CPU (processor) executes by reading the cryptographic protocol security verification program from the storage medium, so that each unit described above is loaded on the main storage unit, while the cryptographic protocol specification input processing unit 110, the verifiable cryptographic protocol specification generating unit 1010, the formal verification unit 120 and the verification result output unit 130 are generated on the main storage unit.

The cryptographic protocol design program executed by the cryptographic protocol design apparatus according to the third embodiment, on the other hand, is configured of modules including each of the aforementioned units (the cryptographic protocol specification design unit 1210, the verifiable cryptographic protocol specification generating unit 1010, the formal verification unit 120, the verification result output unit 130, the cryptographic protocol execution unit). As an actual hardware, the CPU (processor) executes by reading the cryptographic protocol security verification program from the storage medium, so that each unit described above is loaded on the main storage unit, while the cryptographic protocol specification design unit 1210, the verifiable cryptographic protocol specification generating unit 1010, the formal verification unit 120, the verification result output unit 130 and the cryptographic protocol execution unit are generated on the main storage unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cryptographic protocol security verification apparatus comprising:
a formal verification unit verifying a presence or absence of a defect of a process for a party and a first virtual entity based on a description of a verifiable cryptographic protocol specification data,
wherein the verifiable cryptographic protocol specification data includes a first description section containing a description of a process for the party actually involved in the execution of a cryptographic protocol, and a second description section, where the second description section corresponds to an ideal protocol defined by an universal composability, contains a description of the process for the party actually involved in the execution of the cryptographic protocol and a first virtual entity not actually involved in the execution of the cryptographic protocol, and does not contain a description for a second virtual entity not actually involved in the execution of the cryptographic protocol, and
wherein the first virtual entity corresponds to an ideal functionality of the ideal protocol, and the second virtual entity corresponds to a simulator of the ideal protocol.

2. The cryptographic protocol security verification apparatus according to claim 1, further comprising a cryptographic protocol specification input processing unit inputting the verifiable cryptographic protocol specification data,
wherein the formal verification unit verifies, based on the description of the verifiable cryptographic protocol specification data, the presence or absence of a defect of the process for both the party and the first virtual entity in the verifiable cryptographic protocol specification data input by the cryptographic protocol specification input processing unit.

3. The cryptographic protocol security verification apparatus according to claim 1, further comprising a verifiable cryptographic protocol generating unit generating the verifiable cryptographic protocol specification data by deleting the description of the second virtual entity in the cryptographic protocol specification data,
wherein the cryptographic protocol specification data includes the first description section, the second description section containing the description of the process for the party, the first virtual entity and the second virtual entity.

4. The cryptographic protocol security verification apparatus according to claim 3, wherein the verifiable cryptographic protocol generating unit generates the verifiable cryptographic protocol specification data by determining whether the description of the second virtual entity is existent in the second description section, and deleting the description of the second virtual entity when the description of the second virtual entity is determined to be existent in the second description section.

5. The cryptographic protocol security verification apparatus according to claim 4, wherein the verifiable cryptographic protocol generating unit generates the verifiable cryptographic protocol specification data by substituting information utilizable at the time of attack for information exchanged between the second virtual entity and the first virtual entity, and substituting a description for direct distribution of a message from the first virtual entity to the party for a description on a request of the first virtual entity to the second virtual entity for a message distribution to the party when the description of the second virtual entity is determined to be existent in the second description section.

6. The cryptographic protocol security verification apparatus according to claim 4, wherein the verifiable cryptographic protocol generating unit generates the verifiable cryptographic protocol specification data by substituting an information utilizable at the time of attack for the information exchanged between the second virtual entity and the first virtual entity, and substituting a description that the first virtual entity distributes a message to the party without a request for a permission by the second virtual entity for a description that the first virtual entity distributes a message after a distribution permission request is given to the second virtual entity before the message is distributed to the party when the description of the second virtual entity is determined to be existent in the second description section.

7. The cryptographic protocol security verification apparatus according to claim 1, further comprising:
an initial condition storage unit storing a sentence assumed to be correct in an initial process of verification of the cryptographic protocol specification data; and
a proven sentence storage unit storing a sentence proven to be correct in a process of verification of the cryptographic protocol specification data;
wherein the formal verification unit includes
a default goal generating unit generating default goal information providing a provisional goal of inference from the protocol execution definition part containing a description of an execution process of the protocol, and
an inference unit determining whether a sentence contained in the default goal information generated by the default goal generating unit is existent in the initial condition storage unit or the proven sentence storage unit, and inferring that the default goal information is proven to be correct when all the sentences of the default goal information are existent in the initial condition storage unit and the proven sentence storage unit.

8. The cryptographic protocol security verification apparatus according to claim 7, wherein the inference unit further determines whether a sentence contained in an user information is existent in the initial condition storage unit or the proven sentence storage unit using a description of a goal part indicating a final goal contained in the second description section as a user goal, and infers that the absence of a defect is proven when all the sentences of the user goal information are existent in the initial condition storage unit or the proven sentence storage unit.

9. A cryptographic protocol design apparatus comprising:
a cryptographic protocol part storage unit storing a first description part and a second description part, wherein the first description part constituting a first description section providing a description of processes for a party actually involved in a execution of a cryptographic protocol and the second description part constituting a second description section providing a description of processes for the party actually involved in the execution of the cryptographic protocol and for a first virtual entity and a second virtual entity not actually involved in the execution of the cryptographic protocol, these processes being proven to be realized securely by the first description section;
a cryptographic protocol specification design unit generating a cryptographic protocol specification data containing the second description part stored in the cryptographic protocol part storage unit and the first description section newly added;
a verifiable cryptographic protocol generating unit generating a verifiable cryptographic protocol specification data by deleting the description on the second virtual entity from the second description section in the cryptographic protocol specification data generated by the cryptographic protocol specification design unit;
a formal verification unit verifying, based on the description of the verifiable cryptographic protocol specification data, a presence or absence of a defect of the process for both the party and the first virtual entity in the verifiable cryptographic protocol specification data generated by the verifiable cryptographic protocol specification generating unit; and
a cryptographic protocol execution unit generating a realizable cryptographic protocol based on the verifiable cryptographic protocol specification data proven to have no defect by the formal verification unit.

10. A method of verifying a cryptographic protocol security comprising:
verifying a presence or absence of a defect of a process for a party and a first virtual entity based on a description of a verifiable cryptographic protocol specification data,
wherein the verifiable cryptographic protocol specification data includes a first description section containing a description of a process for the party actually involved in the execution of a cryptographic protocol, and a second description section, where the second description section corresponds to an ideal protocol defined by an universal composability, contains a description of the process for the party actually involved in the execution of the cryptographic protocol and a first virtual entity not actually involved in the execution of the cryptographic protocol, and does not contain a description for a second virtual entity not actually involved in the execution of the cryptographic protocol, and
wherein the first virtual entity corresponds to an ideal functionality of the ideal protocol, and the second virtual entity corresponds to a simulator of the ideal protocol.

11. A method of designing a cryptographic protocol comprising:
generating a cryptographic protocol specification data including a second description part being stored in a cryptographic protocol part storage unit and a newly added first description section, wherein the cryptographic protocol part storage unit store a first description part constituting the first description section providing a description of a process for a party actually involved in an execution of a cryptographic protocol and the second description part constituting a second description section providing a description of processes for the party actually involved in the execution of the cryptographic protocol and for a first virtual entity and a second virtual entity not actually involved in the execution of the cryptographic protocol, these processes being proven to be realized securely by the first description section;
generating a verifiable cryptographic protocol specification data by deleting the description on the second virtual entity from the second description section in the cryptographic protocol specification data generated;
verifying, based on the description of the verifiable cryptographic protocol specification data, a presence or absence of a defect of the process for both the party and the first virtual entity in the verifiable cryptographic protocol specification data generated; and
generating a realizable cryptographic protocol based on the verifiable cryptographic protocol specification data proven to have no defect.

12. A computer program product having a computer readable medium including programmed instructions for verifying a cryptographic protocol security in a storage medium, wherein the instructions, when executed by a computer, cause the computer to perform:
verifying a presence or absence of a defect of a process for a party and a first virtual entity based on a description of a verifiable cryptographic protocol specification data,
wherein the verifiable cryptographic protocol specification data includes a first description section containing a description of a process for the party actually involved in the execution of a cryptographic protocol, and a second description section, where the second description section corresponds to an ideal protocol defined by an universal composability, contains a description of the process for the party actually involved in the execution of the cryptographic protocol and a first virtual entity not actually involved in the execution of the cryptographic protocol, and does not contain a description for a second virtual entity not actually involved in the execution of the cryptographic protocol, and
wherein the first virtual entity corresponds to an ideal functionality of the ideal protocol, and the second virtual entity corresponds to a simulator of the ideal protocol.

13. A computer program product having a computer readable medium including programmed instructions for designing a cryptographic protocol in a storage medium, wherein the instructions, when executed by a computer, cause the computer to perform:
generating a cryptographic protocol specification data including a second description part being stored in a cryptographic protocol part storage unit and a newly added first description section, wherein the cryptographic protocol part storage unit store a first description part constituting the first description section providing a description of a process for a party actually involved in an execution of a cryptographic protocol and the second description part constituting a second description section providing a description of processes for the party actually involved in the execution of the cryptographic protocol and for a first virtual entity and a second virtual entity not actually involved in the execution of the cryptographic protocol, these processes being proven to be realized securely by the first description section;
generating a verifiable cryptographic protocol specification data by deleting the description on the second virtual entity from the second description section in the cryptographic protocol specification data generated;
verifying, based on the description of the verifiable cryptographic protocol specification data, a presence or absence of a defect of the process for both the party and the first virtual entity in the verifiable cryptographic protocol specification data generated; and
generating a realizable cryptographic protocol based on the verifiable cryptographic protocol specification data proven to have no defect.
